(19) United States
(12) Patent Application Publication
(10) Pub. No.: US 2025/0379257 A1
(43) Pub. Date: Dec. 11, 2025

(54) ELECTRODE ASSEMBLY, SECONDARY BATTERY INCLUDING THE SAME, AND METHOD FOR MANUFACTURING THE ELECTRODE ASSEMBLY

(71) Applicant: SAMSUNG SDI CO., LTD., Yongin-Si Gyeonggi-do (KR)

(72) Inventors: Bo Hyun KIM, Yongin-Si (KR); Jongnam CHOI, Yongin-Si (KR); Seungyeol YOO, Yongin-Si (KR); Jinhyeong JO, Yongin-Si (KR); Hyeokjoo KIM, Yongin-Si (KR); Heonhee KIM, Yongin-Si (KR); Duckhyun KIM, Yongin-Si (KR); Woonsuk JANG, Yongin-Si (KR)

(21) Appl. No.: 19/006,745

(22) Filed: Dec. 31, 2024

(30) Foreign Application Priority Data
Jun. 7, 2024 (KR) 10-2024-0074503

(51) Int. Cl. H01M 10/0583; H01M 10/0525; H01M 50/46; H01M 50/466

(52) U.S. Cl. CPC H01M 10/0583; H01M 10/0525; H01M 50/46; H01M 50/466

(57) ABSTRACT

An electrode assembly includes: a separator structure including a first separator and a second separator; a plurality of negative electrode plates spaced from each other along a first direction between the first separator and the second separator; and a plurality of positive electrode plates on the negative electrode plates with the first separator or the second separator therebetween. The separator structure includes a bending portion where the first separator and the second separator are bonded to each other, and the bending portion has a cutaway portion through which the first separator and the second separator are cut in a second direction perpendicular to the first direction.

### CROSS-REFERENCE TO RELATED APPLICATION

The present application claims priority to and the benefit of Korean Patent Application No. 10-2024-0074503, filed on Jun. 7, 2024, in the Korean Intellectual Property Office, the entire disclosure of which is incorporated by reference herein.

### BACKGROUND

### 1. Field

Aspects of embodiments of the present disclosure relate to an electrode assembly, a secondary battery including the electrode assembly, and a method of manufacturing the electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

As the capacity of secondary batteries are increased, the capacity and the viscosity of an electrolyte injected into the secondary batteries may also increase. However, if the capacity or the viscosity of the electrolyte increases, an impregnation property of the electrolyte may decrease, which may increase a time to impregnate the electrolyte. In addition, if the electrolyte is not uniformly impregnated, a performance of the secondary battery may deteriorate. Accordingly, the productivity or the quality of secondary batteries may decrease.

Embodiments of the present disclosure may be directed to an electrode assembly, a secondary battery including the electrode assembly, and a method of manufacturing the electrode assembly.

These and other aspects and features of the present disclosure will be described in or will be apparent from the following description of embodiments of the present disclosure.

According to one or more embodiments of the present disclosure, an electrode assembly includes: a separator structure including a first separator and a second separator; a plurality of negative electrode plates spaced from each other along a first direction between the first separator and the second separator; and a plurality of positive electrode plates on the negative electrode plates with the first separator or the second separator therebetween. The separator structure includes a bending portion where the first separator and the second separator are bonded to each other, and the bending portion has a cutaway portion through which the first separator and the second separator are cut in a second direction perpendicular to the first direction.

In an embodiment, the cutaway portion may have a plurality of holes.

In an embodiment, the cutaway portion may have a straight line shape.

In an embodiment, a length of the cutaway portion may be less than a ratio of a length of a side of an adjacent negative electrode plate from among the negative electrode plates, the side being parallel to the second direction.

In an embodiment, a length of a first side parallel to the second direction of an adjacent negative electrode plate from among the negative electrode plates may be longer than a length of a second side of the adjacent negative electrode plate perpendicular to the first side, and a length of the cutaway portion may be a value obtained by subtracting the length of the second side from the length of the first side.

In an embodiment, a length of a first side parallel to the second direction of an adjacent negative electrode plate from among the negative electrode plates may be shorter than or equal to a length of a second side of the adjacent negative electrode plate perpendicular to the first side, and the length of the cutaway portion may be half the length of the first side.

In an embodiment, the cutaway portion may be located at a center of the bending portion with respect to the second direction.

In an embodiment, the bending portion may be located in a portion where the separator structure and the negative electrode plates are not in contact with each other, and in a portion where the separator structure and the positive electrode plates are not in contact with each other.

In an embodiment, the electrode assembly may further include: a plurality of negative electrode tabs joined to the negative electrode plates; and a plurality of positive electrode tabs joined to the positive electrode plates.

According to one or more embodiments of the present disclosure, a method of manufacturing an electrode assembly, includes: disposing a plurality of negative electrode plates to be spaced from each other along a first direction between a first separator and a second separator of a separator structure; laminating upper surfaces of the negative electrode plates and the first separator to each other, and lower surfaces of the negative electrode plates and the second separator to each other; alternately disposing a plurality of positive electrode plates on the negative electrode plates with the first separator or the second separator therebetween; laminating a first set of positive electrode plates from among the positive electrode plates and the first separator to each other, or a second set of positive electrode plates from among the positive electrode plates and the second separator to each other; forming a bending portion by bonding the first separator and the second separator to each other; forming a cutaway portion by cutting the bending portion in a second direction perpendicular to the first direction; and folding the electrode assembly in a zigzag manner by bending the bending portion, so that the first set of positive electrode plates from among the positive electrode plates face the first separator and the second set of positive electrode plates from among the positive electrode plates face the second separator.

In an embodiment, the forming of the cutaway portion may include cutting the bending portion in a shape of a dashed line.

In an embodiment, the forming of the cutaway portion may include cutting the bending portion in a shape of a straight line.

In an embodiment, the forming of the cutaway portion may include cutting the bending portion by a length less than a ratio of a length of a side parallel to the second direction of an adjacent negative electrode plate from among the negative electrode plates.

In an embodiment, a length of a first side parallel to the second direction of an adjacent negative electrode plate form among the negative electrode plates may be longer than a length of a second side of the adjacent negative electrode plate perpendicular to the first side, and the forming of the cutaway portion may include cutting the bending portion by a length obtained by subtracting the length of the second side from the length of the first side.

In an embodiment, a length of a first side parallel to the second direction of an adjacent negative electrode plate from among the negative electrode plates may be shorter than or equal to a length of a second side of the adjacent negative electrode plate perpendicular to the first side, and the forming of the cutaway portion may include cutting the bending portion by half the length of the first side.

In an embodiment, the cutaway portion may be disposed at a center of the bending portion with respect to the second direction.

In an embodiment, the bending portion may be disposed in a portion where the separator structure and the negative electrode plates are not in contact with each other, and in a portion where the separator structure and the positive electrode plates are not in contact with each other.

According to one or more embodiments of the present disclosure, a secondary battery includes: an electrode assembly; and a case accommodating the electrode assembly. The electrode assembly includes: a separator structure including a first separator and a second separator; a plurality of negative electrode plates spaced from each other along a first direction between the first separator and the second separator; and a plurality of positive electrode plates on the negative electrode plates with the first separator or the second separator therebetween. The separator structure further includes a bending portion where the first separator and the second separator are bonded to each other, and the bending portion has a cutaway portion through which the first separator and the second separator are cut in a second direction perpendicular to the first direction.

In an embodiment, the cutaway portion may have a plurality of holes.

In an embodiment, the cutaway portion may have a straight line shape.

According to some embodiments of the present disclosure, because at least a portion of a separator structure surrounding (e.g., around a periphery of) the negative electrode plate and/or the positive electrode plate may have holes therein, a material exchange between the negative electrode plate and/or the positive electrode plate and the outside may be more effectively achieved. As such, a process of impregnating the negative electrode plate and/or the positive electrode plate with the electrolyte may be more efficiently performed. In some embodiments, a process of discharging gas generated from the negative electrode plate and/or the positive electrode plate during charging or discharging of the secondary battery may be more efficiently performed.

According to some embodiments of the present disclosure, an electrolyte movement path may be ensured within the electrode assembly, and thus, the electrolyte within the electrode assembly may be uniformly or substantially uniformly impregnated, and the electrolyte impregnation time may be decreased. In some embodiments, the process of discharging gas generated during charging or discharging of the secondary battery to the outside may be more efficiently performed.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates an example of an electrode assembly according to an embodiment of the present disclosure.

FIG. 2 illustrates an example in which the electrode assembly is folded in a zigzag manner according to an embodiment of the present disclosure.

FIG. 3 illustrates an example of an electrode assembly before being folded according to an embodiment of the present disclosure.

FIG. 4 illustrates a cross-sectional view taken along the line a-a′ of FIG. 3 according to an embodiment of the present disclosure.

FIG. 5 illustrates a cross-sectional view taken along the line b-b′ of FIG. 3 according to an embodiment of the present disclosure.

FIG. 6 illustrates a cross-sectional view taken along the line a-a′ of FIG. 3 after the electrode assembly is folded according to an embodiment of the present disclosure.

FIG. 7 illustrates a cross-sectional view taken along the line b-b′ of FIG. 3 after the electrode assembly is folded according to an embodiment of the present disclosure.

FIG. 8 illustrates an example of a cutaway portion according to an embodiment of the present disclosure.

FIG. 9 illustrates an example of a cutaway portion according to an embodiment of the present disclosure.

FIG. 10 illustrates an example of a process of manufacturing an electrode assembly according to an embodiment of the present disclosure.

FIG. 11 illustrates a flowchart showing an example of a method of manufacturing an electrode assembly according to an embodiment of the present disclosure.

FIG. 12 illustrates an example of a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The singular forms as used herein include the plural forms, unless the context clearly specifies the singular forms. In addition, the plural forms as used herein include the singular forms, unless the context clearly specifies the plural forms. It will be understood that the terms “comprise,” “include,” or “have” as used herein specify the presence of the stated elements, but do not preclude the presence or addition of one or more other elements.

In the present disclosure, the sizes and relative sizes of layers and regions shown in the drawings may be exaggerated for clarity of illustration. In other words, the sizes shown in the drawings are provided for convenience of illustration, and are not limited thereto. In addition, the same reference numerals denote the same elements throughout the specification.

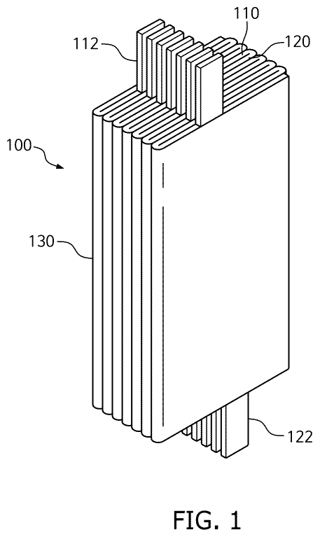

FIG. 1 illustrates an example of an electrode assembly 100 according to an embodiment of the present disclosure.

In an embodiment, the electrode assembly 100 may include a negative electrode plate 110 in which a negative electrode active material (e.g., graphite, carbon, or the like) is coated on a negative electrode current collector plate, a positive electrode plate 120 in which a positive electrode active material (e.g., a transition metal oxide, such as LiCoO₂, LiNiO₂, LiMn₂O₄, or the like) is coated on a positive electrode current collector plate, and a separator 130 located between the negative electrode plate 110 and the positive electrode plate 120 to prevent or substantially prevent a short circuit therebetween and enable (e.g., only enable) the movement of lithium ions. For example, the negative electrode current collector plate may be formed of a copper (Cu) foil, the positive electrode current collector plate may be formed of an aluminum (Al) foil, and the separator 130 may be formed of polyethylene (PE) or polypropylene (PP), but the present disclosure is not limited thereto.

In some embodiments, a negative electrode tab 112 that protrudes and extends upward by a suitable length (e.g., a certain or predetermined length) and serves as an electric path for guiding a current formed in the electrode assembly 100 to the outside may be connected to (e.g., joined to, coupled to, or attached to) the negative electrode plate 110. A positive electrode tab 122 that protrudes and extends downward by a suitable length (e.g., a certain or predetermined length) and serves as an electric path for guiding a current formed in the electrode assembly 100 to the outside may be connected to (e.g., joined to, coupled to, or attached to) the positive electrode plate 120. In some embodiments, for example, the negative electrode tab 112 may be formed of copper (Cu) or nickel (Ni), and the positive electrode tab 122 may be formed of aluminum (Al), but the present disclosure is not limited thereto.

In an embodiment, for the positive electrode plate 120, the positive electrode substrate may include (e.g., may be composed of) an aluminum foil, and the positive electrode active material may include, for example, a transition metal oxide. As the positive electrode active material, a compound (e.g., a lithiated intercalation compound) that is capable of reversibly intercalating and deintercalating lithium may be used. In more detail, one or more complex oxides of lithium and a metal selected from cobalt, manganese, nickel, and/or a suitable combination thereof may be used. The complex oxide may be a lithium transition metal complex oxide, and specific examples thereof may include lithium nickel-based oxide, lithium cobalt-based oxide, lithium manganese-based oxide, lithium iron phosphate-based compound, cobalt-free nickel-manganese-based oxide, or a combination thereof.

As an example, a compound represented by any of the following formulas may be used. LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high nickel-based positive electrode active materials may achieve a high capacity, and may be applied to high-capacity, high-density lithium secondary batteries.

In an embodiment, for the negative electrode plate 110, the negative electrode substrate may include (e.g., may be composed of), for example, a copper foil or a nickel foil, and the negative electrode active material may include, for example, graphite. The negative electrode active material may include a suitable material capable of reversibly intercalating/deintercalating lithium ions, a lithium metal, an alloy of a lithium metal, a material capable of doping and dedoping lithium, or a transition metal oxide. The material capable of reversibly intercalating/deintercalating lithium ions is a carbon-based negative electrode active material, and may include, for example, crystalline carbon, amorphous carbon, or a suitable combination thereof. Examples of the crystalline carbon may include graphite, such as natural graphite or artificial graphite, and examples of the amorphous carbon may include soft carbon or hard carbon, a mesophase pitch carbide, and calcined coke.

As the alloy of the lithium metal, an alloy of lithium and a metal selected from Na, K, Rb, Cs, Fr, Be, Mg, Ca, Sr, Si, Sb, Pb, In, Zn, Ba, Ra, Ge, Al, and/or Sn may be used.

As the material capable of doping and dedoping lithium, a Si-based negative electrode active material or a Sn-based negative electrode active material may be used. The Si-based negative electrode active material may include silicon, a silicon-carbon composite, SiOₓ (0<x≤2), a Si-Q alloy (where Q is selected from an alkali metal, an alkaline-earth metal, a Group 13 element, a Group 14 element (excluding Si), a Group 15 element, a Group 16 element, a transition metal, and a rare earth element), and a suitable combination thereof. The Sn-based negative electrode active material may include Sn, SnO₂, a Sn-based alloy, or a suitable combination thereof.

The silicon-carbon composite may be a composite of silicon and amorphous carbon. According to an embodiment, the silicon-carbon composite may be in the form of silicon particles, and amorphous carbon coated on the surface of the silicon particles. For example, the silicon-carbon composite may include a secondary particle (e.g., a core) in which primary silicon particles are assembled, and an amorphous carbon coating layer (e.g., a shell) on the surface of the secondary particle. The amorphous carbon may also be between the primary silicon particles, and for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

In an embodiment, the separator 130 may serve to prevent a short circuit between the negative electrode plate 110 and the positive electrode plate 120, while allowing the movement of lithium ions. The separator 130 may include, for example, a polyethylene film, a polypropylene film, a polyethylene-polypropylene film, and/or the like.

Although FIG. 1 illustrates that the negative electrode tab 112 extends from the top of the negative electrode plate 110 and is connected (e.g., is joined, coupled, or attached) thereto, the position at which the negative electrode tab 112 is connected (e.g., is joined, coupled, or attached) is not limited thereto. For example, the negative electrode tab 112 may extend from the bottom of the negative electrode plate 110, and may be joined thereto. Similarly, although FIG. 1 illustrates that the positive electrode tab 122 extends from the bottom of the positive electrode plate 120 and is connected (e.g., is joined, coupled, or attached) thereto, the position at which the positive electrode tab 122 is connected (e.g., is joined, coupled, or attached) is not limited thereto. For example, the positive electrode tab 122 may extend from the top of the positive electrode plate 120 and be joined thereto.

Although FIG. 1 illustrates that the negative electrode tab 112 is connected to (e.g., joined to, coupled to, or attached to) the upper surface of the negative electrode plate 110 and the positive electrode tab 122 is connected to (e.g., joined to, coupled to, or attached to) the lower surface of the positive electrode plate 120, the present disclosure is not limited thereto. For example, the negative electrode tab 112 may be connected to (e.g., joined to, coupled to, or attached to) the upper surface of the negative electrode plate 110, and the positive electrode tab 122 may also be connected to (e.g., joined to, coupled to, or attached to) the upper surface of the positive electrode plate 120, and vice versa. In this case, the negative electrode tab 112 and the positive electrode tab 122 may not be connected to (e.g., joined to, coupled to, or attached to) the center of the upper or lower surface of the negative electrode plate 110 and the positive electrode plate 120.

In an embodiment, the electrode assembly 100 may be formed by stacking the separator 130 between the positive electrode plate 120 and the negative electrode plate 110.

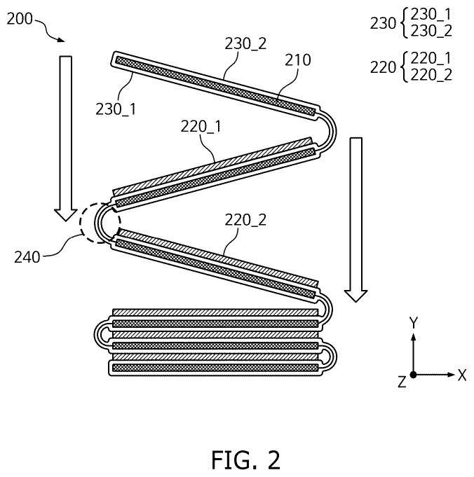

FIG. 2 illustrates an example in which the electrode assembly 200 is folded in a zigzag manner according to an embodiment of the present disclosure.

Referring to FIG. 2, the electrode assembly 200 according to an embodiment of the present disclosure may include a separator structure 230 including a first separator 230_1 and a second separator 230_2, a plurality of negative electrode plates 210 spaced apart between the first separator 230_1 and the second separator 230_2 in the Y direction, and a plurality of positive electrode plates 220 facing the negative electrode plates 210 with the first separator 230_1 or the second separator 230_2 therebetween.

In an embodiment, the separator structure 230 may include a bending portion 240 where the first separator 230_1 and the second separator 230_2 are connected to (e.g., joined to, coupled to, or attached to) each other. The bending portion 240 may be disposed in a portion other than a portion where the separator structure 230 and the negative electrode plate 210 are in contact with each other, and other than a portion where the separator structure 230 and the positive electrode plate 220 are in contact with each other. In some embodiments, the first separator 230_1 and the second separator 230_2 may be connected to each other at the end of the electrode assembly 200. In other embodiments, the first separator 230_1 and the second separator 230_2 may not be connected to each other, and other components may be additionally connected at the end of the electrode assembly 200.

In an embodiment, the negative electrode plates 210 may be inserted and disposed between the first separator 230_1 and the second separator 230_2. The negative electrode plates 210 may be spaced apart from each other by the same or substantially the same distance with the bending portion 240 therebetween.

In an embodiment, the positive electrode plates 220 may be disposed to face the negative electrode plates 210 with the first separator 230_1 or the second separator 230_2 therebetween. In some embodiments, each of a first set of positive electrode plates 220_1 from among the positive electrode plates 220 may be disposed to face one of the negative electrode plates 210 with the first separator 230_1 therebetween. Each of a second set of positive electrode plates 220_2 from among the positive electrode plates 220 may be disposed to face one of the negative electrode plates 210 with the second separator 230_2 therebetween. Each of the first set of positive electrode plates 220_1 from among the positive electrode plates 220 and each of the second set of positive electrode plates 220_2 from among the positive electrode plates 220 may be alternately disposed to face the negative electrode plates 210.

In an embodiment, as illustrated in FIG. 2, the electrode assembly 200 may be folded in a zigzag manner by bending the bending portion 240, so that the first set of positive electrode plates 220_1 from among the positive electrode plates 220 face the first separator 230_1, and the second set of positive electrode plates 220_2 from among the positive electrode plates 220 face the second separator 230_2. Each of the first set of positive electrode plates 220_1 and each of the second set of positive electrode plates 220_2 may be alternately disposed to face the negative electrode plates 210, so that in a case where the electrode assembly 200 is folded in a zigzag manner, the negative electrode plates 210 and the positive electrode plates 220 may be separated from each other by the separator structure 230.

In an embodiment, the electrode assembly 200 may be folded and stacked in a zigzag manner in the direction of the arrow illustrated in FIG. 2. The stacked electrode assembly 200 may be accommodated in a case that accommodates the electrode assembly 200 included in the secondary battery.

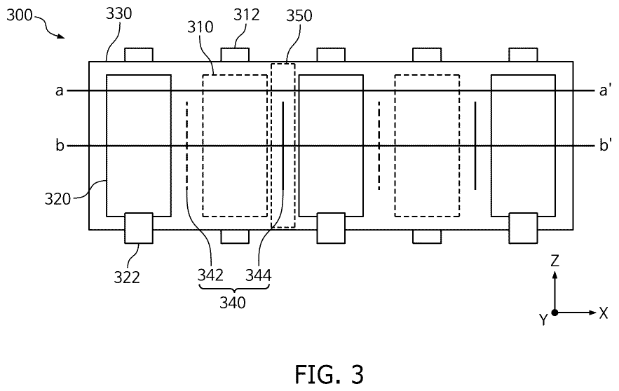

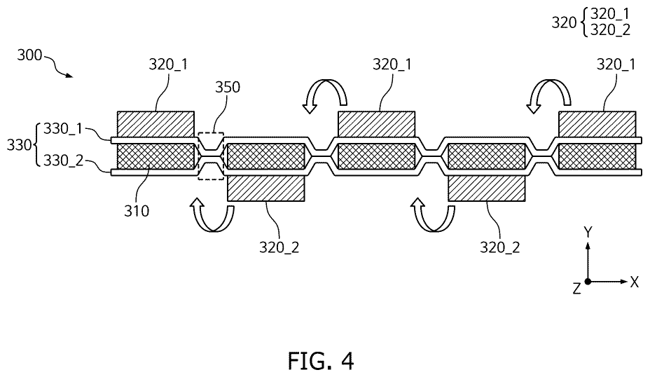

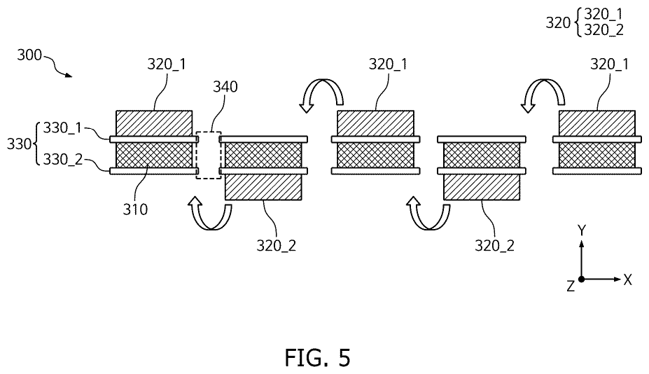

FIG. 3 illustrates an example of an electrode assembly 300 before being folded according to an embodiment of the present disclosure. FIG. 4 illustrates a cross-sectional view taken along the line a-a′ of FIG. 3 according to an embodiment of the present disclosure. FIG. 5 illustrates a cross-sectional view taken along the line b-b′ of FIG. 3 according to an embodiment of the present disclosure.

The electrode assembly 300 according to an embodiment of the present disclosure may include a plurality of negative electrode plates 310, a plurality of positive electrode plates 320, and a separator structure 330. The positive electrode plates 320 may include a first set of positive electrode plates 320_1 and a second set of positive electrode plates 320_2. The separator structure 330 may include a first separator 330_1 and a second separator 330_2.

In an embodiment, the electrode assembly 300 may include the negative electrode plates 310 spaced apart from each other in the X direction. The negative electrode plates 310 may be spaced apart from each other at the same intervals as each other. Referring to FIGS. 4 and 5, the negative electrode plates 310 may be disposed between the first separator 330_1 and the second separator 330_2 included in the separator structure 330.

In some embodiments, the electrode assembly 300 may include the positive electrode plates 320 disposed to face the negative electrode plates 310 with the first separator 330_1 or the second separator 330_2 therebetween. Each of the first set of positive electrode plates 320_1 from among the positive electrode plates 320 may be disposed to face one of the negative electrode plates 310 with the first separator 330_1 therebetween. Each of the second set of positive electrode plates 320_2 from among the positive electrode plates 320 may be disposed to face one of the negative electrode plates 310 with the second separator 330_2 therebetween. Each of the first set of positive electrode plates 320_1 from among the positive electrode plates 320 and each of the second set of positive electrode plates 320_2 from among the positive electrode plates 320 may be alternately disposed to face the negative electrode plates 310. Accordingly, the positive electrode plates 320 illustrated in FIG. 3 may be the first set of positive electrode plates 320_1 or the second set of positive electrode plates 320_2.

In an embodiment, the separator structure 330 may include a bending portion 350 where the first separator 330_1 and the second separator 330_2 are connected to (e.g., joined to, coupled to, or attached to) each other. The bending portion 350 may be disposed in a portion other than a portion where the separator structure 330 and the negative electrode plates 310 are in contact with each other, and a portion other than where the separator structure 330 and the positive electrode plates 320 are in contact with each other. The bending portion 350 may be a portion that is bent when the electrode assembly 300 is folded in a zigzag manner.

In an embodiment, the bending portion 350 may include a cutaway portion 340 where the separator structure 330 is cut in the Z direction. Because the cutaway portion 340 is disposed at the bending portion 350, which is a portion where the first separator 330_1 and the second separator 330_2 are connected to (e.g., joined to, coupled to, or attached to) each other, the first separator 330_1 and the second separator 330_2 may be cut to form the cutaway portion 340.

In an embodiment, the cutaway portion 340 may include a plurality of holes. In some embodiments, the cutaway portion 340 may be a portion of the separator structure 330 that is cut in the shape of a dashed line. In a case where the cutaway portion 340 includes a plurality of holes, the sizes of the holes may be equal to or substantially equal to each other. In other embodiments, the sizes of the holes may be different from each other. In some embodiments, the holes may be spaced apart from each other at the same intervals as each other. In some embodiments, the holes may be spaced apart from each other at different intervals from each other. The number, size, and intervals of the holes are not particularly limited.

In other embodiments, the cutaway portion 340 may be a portion of the separator structure 330 that is cut in the shape of a straight line. In FIG. 3, the shape of the cutaway portion 340 is illustrated in various ways for convenience of illustration, but the shape of the cutaway portion 340 is not limited thereto. Accordingly, the separator structure 330 may be cut in the shape of a straight line 344. In other embodiments, the separator structure 330 may be cut in the shape of a dashed line 342. In some embodiments, the separator structure 330 may be cut alternately in the shape of the straight line 344 and in the shape of the dashed line 342, as illustrated in FIG. 3. In some embodiments, the cutaway portion 340 may be in the shape of a surface object, such as a rectangle, rather than a line, such as a straight line or a dashed line.

In an embodiment, the length of the cutaway portion 340 may be less than a ratio (e.g., a predetermined ratio) of the length of a side of the negative electrode plate 310 parallel to the Z direction. In some embodiments, the length of the cutaway portion 340 may be less than a ratio (e.g., a predetermined ratio) of the height of the negative electrode plate 310. For example, the length of the cutaway portion 340 may be less than 90% of the height of the negative electrode plate 310, but the present disclosure is not limited thereto. Accordingly, even in a case where the separator structure 330 is cut by the length of the cutaway portion 340, only a portion of the separator structure 330 may be cut. Accordingly, the separator structure 330 may not be completely cut with respect to the Z direction.

In an embodiment, a negative electrode tab 312 that protrudes and extends in the positive Z direction by a length (e.g., a certain or predetermined length), and serves as an electric path for guiding a current formed in the electrode assembly 300 to the outside, may be connected to (e.g., joined to, coupled to, or attached to) the negative electrode plate 310. A positive electrode tab 322 that protrudes and extends in the negative Z direction by a length (e.g., a certain or predetermined length), and serves as an electric path for guiding a current formed in the electrode assembly 300 to the outside, may be connected to (e.g., joined to, coupled to, or attached to) the positive electrode plate 320. In other embodiments, the negative electrode tab 312 that protrudes and extends in the negative Z direction by the length may be connected to (e.g., joined to, coupled to, or attached to) the negative electrode plate 310. The positive electrode tab 322 that protrudes and extends in the positive Z direction by the length may be connected to (e.g., joined to, coupled to, or attached to) the positive electrode plate 320.

In another embodiment, the negative electrode tab 312 and the positive electrode tab 322 may be connected to (e.g., joined to, coupled to, or attached to) the negative electrode plate 310 and the positive electrode plate 320, respectively, while extending in the same direction as each other by a length (e.g., a predetermined length). For example, the negative electrode tab 312 and the positive electrode tab 322 may be connected to (e.g., joined to, coupled to, or attached to) the negative electrode plate 310 and the positive electrode plate 320, respectively, while extending in the positive Z direction by the length. In this case, the negative electrode tab 312 and the positive electrode tab 322 may not be connected to (e.g., joined to, coupled to, or attached to) the negative electrode plate 310 and the positive electrode plate 320 while protruding and extending from the center of the negative electrode plate 310 and the positive electrode plate 320 with respect to the X direction. A position where the negative electrode tab 312 and the positive electrode tab 322 are connected to (e.g., joined to, coupled to, or attached to) each other is not limited thereto.

In an embodiment, referring to FIGS. 4 and 5, the negative electrode plates 310 may be spaced apart from each other between the first separator 330_1 and the second separator 330_2 in the X direction. In some embodiments, the positive electrode plates 320 may be disposed to face the negative electrode plates 310 with the first separator 330_1 or the second separator 330_2 therebetween. In some embodiments, the first set of positive electrode plates 320_1 from among the positive electrode plates 320 may be disposed to face the negative electrode plates 310 with the first separator 230_1 therebetween. The second set of positive electrode plates 320_2 from among the positive electrode plates 320 may be disposed to face the negative electrode plates 310 with the second separator 330_2 therebetween. The first set of positive electrode plates 320_1 and the second set of positive electrode plates 320_2 may be alternately disposed.

In an embodiment, the bending portion 350 may be a portion that is bent in a case where the electrode assembly 300 is folded. Referring to FIGS. 4 and 5, the electrode assembly 300 may be alternately folded in the direction of the arrows shown therein. In some embodiments, the electrode assembly 300 may be alternately folded by bending the bending portion 350, so that the first set of positive electrode plates 320_1 from among the positive electrode plates 320 face the first separator 330_1, and the second set of positive electrode plates 320_2 from among the positive electrode plates 320 face the second separator 330_2. The first set of positive electrode plates 320_1 and the second set of positive electrode plates 320_2 may be alternately disposed to face the negative electrode plates 310, so that in a case where the electrode assembly 300 is folded, the negative electrode plates 310 and the positive electrode plates 320 may be separated from each other by the separator structure 330.

In an embodiment, the bending portion 350 may include the cutaway portion 340 where the separator structure 330 is cut. As illustrated in FIG. 5, the separator structure 330 may exist in a broken form at the cutaway portion 340.

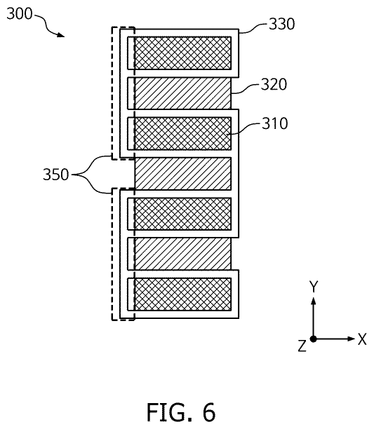

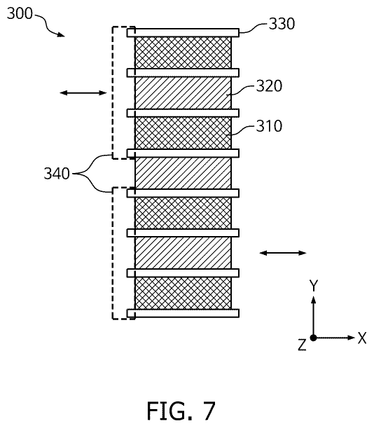

FIG. 6 illustrates a cross-sectional view taken along the line a-a′ of FIG. 3 after the electrode assembly is folded according to an embodiment of the present disclosure. FIG. 7 illustrates a cross-sectional view taken along the line b-b′ of FIG. 3 after the electrode assembly is folded according to an embodiment of the present disclosure.

Referring to FIGS. 6 and 7, the electrode assembly 300 may be folded and stacked in a zigzag manner. In an embodiment, the separator structure 330 may be disposed on the upper and lower surfaces of the negative electrode plate 310, and the separator structure 330 may be disposed on the upper and lower surfaces of the positive electrode plate 320. The separator structure 330 may include a first separator and a second separator. The negative electrode plate 310 and the positive electrode plate 320 may be separated from each other by the separator structure 330, and may not be in contact with each other. As such, a short circuit phenomenon of the electrode assembly 300 may be prevented or substantially prevented.

Referring to FIG. 6, in an embodiment, the electrode assembly 300 may include a bending portion 350, which may be a section where the electrode assembly 300 is folded. The bending portion 350 may be a portion where the first separator 330_1 and the second separator 330_2 are connected (e.g., bonded or attached) to each other. As illustrated in FIG. 6, in a case where the electrode assembly 300 is folded, the negative electrode plate 310 may be surrounded (e.g., around a periphery thereof) by the separator structure 330. Because the separator structure 330 surrounds (e.g., around a periphery of) the negative electrode plate 310 in the X and Y directions, a process of impregnating the negative electrode plate 310 with an electrolyte and/or a process of discharging gas to the outside of the negative electrode plate 310 may be performed in the Z direction. Accordingly, a process of impregnating the negative electrode plate 310 with an electrolyte and/or a process of discharging gas generated from the negative electrode plate 310 during charging or discharging of the secondary battery may not be performed efficiently or may be performed less efficiently. This may also apply to the positive electrode plate 320. As such, in some embodiments, a process of impregnating the positive electrode plate 320 with an electrolyte by the separator structure 330 disposed around the positive electrode plate 320 and/or a process of discharging gas generated in the positive electrode plate 320 during charging or discharging of the secondary battery may not be performed efficiently or may be performed less efficiently.

Referring to FIG. 7, in an embodiment, the electrode assembly 300 may include a cutaway portion 340 where the separator structure 330 is cut. The cutaway portion 340 may be a portion where the first separator 330_1 and the second separator 330_2 are cut in the Z direction. As illustrated in FIG. 7, the separator structure 330 surrounding (e.g., around a periphery of) the negative electrode plate 310 and/or the positive electrode plate 320 may be cut, thereby effectively exchanging materials between the negative electrode plate 310 and/or the positive electrode plate 320 and the outside. As such, the process of impregnating the negative electrode plate 310 and/or the positive electrode plate 320 with the electrolyte may be more efficiently performed. In some embodiments, the process of discharging gas generated from the negative electrode plate 310 and/or the positive electrode plate 320 during charging or discharging of the secondary battery may be more efficiently performed.

As such, the electrolyte movement path may be ensured within the electrode assembly 300, and thus, the electrolyte within the electrode assembly 300 may be uniformly impregnated, and the electrolyte impregnation time may be reduced. In some embodiments, the process of discharging gas generated during charging or discharging of the secondary battery to the outside may be more effectively performed.

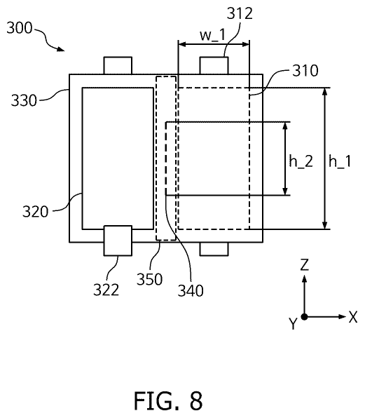

FIG. 8 illustrates an example of the cutaway portion according to an embodiment of the present disclosure.

Referring to FIG. 8, the electrode assembly 300 may include a cutaway portion 340 where the separator structure 330 is cut in the Z direction.

In an embodiment, a length h_2 of the cutaway portion 340 may be determined according to a size and a shape of the negative electrode plate 310. In some embodiments, in a case where a length h_1 of a first side of the negative electrode plate 310, which is parallel to or substantially parallel to the Z direction, is longer than a length w_1 of a second side of the negative electrode plate 310, which is perpendicular to or substantially perpendicular to the first side, the length h_2 of the cutaway portion 340 may be a value obtained by subtracting the length w_1 of the second side from the length h_1 of the first side. As such, the length h_2 of the cutaway portion 340 may be minimized or reduced, and the electrolyte in the electrode assembly 300 may be more effectively impregnated.

In an embodiment, the cutaway portion 340 may be disposed at the center of the bending portion 350 with respect to the Z direction. For example, the center of the cutaway portion 340 in the Z direction may coincide or overlap with the center of the bending portion 350 in the Z direction. By disposing the cutaway portion 340 in the center of the bending portion 350, the electrolyte may be impregnated into the negative electrode plate 310 and/or the positive electrode plate 320 in a shortest route. Accordingly, the electrolyte impregnation time in the electrode assembly 300 may be reduced. In some embodiments, the uniformity of the electrolyte impregnation within the electrode assembly 300 may be improved.

As such, the electrolyte movement path may be ensured within the electrode assembly 300, and thus, the electrolyte within the electrode assembly 300 may be uniformly or substantially uniformly impregnated, and the electrolyte impregnation time may be reduced (e.g., may be shortened). In some embodiments, the process of discharging gas generated during charging or discharging of the secondary battery to the outside may be more efficiently performed.

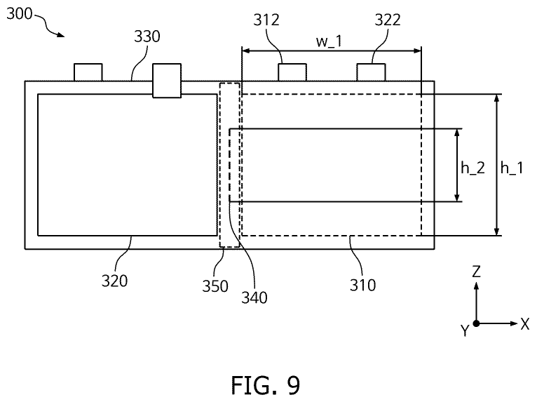

FIG. 9 illustrates an example of the cutaway portion according to an embodiment of the present disclosure.

Referring to FIG. 9, the electrode assembly 300 may include a cutaway portion 340 where the separator structure 330 is cut in the Z direction.

In an embodiment, a length h_2 of the cutaway portion 340 may be determined according to the size and the shape of the negative electrode plate 310. In some embodiments, in a case where a length h_1 of a first side of the negative electrode plate 310, which is parallel to or substantially parallel to the Z direction, is shorter than or equal to a length w_1 of a second side of the negative electrode plate 310, which is perpendicular to or substantially perpendicular to the first side, the length h_2 of the cutaway portion 340 may be half the length h_1 of the first side. As such, the length h_2 of the cutaway portion 340 may be minimized or reduced, and the electrolyte in the electrode assembly 300 may be more effectively impregnated.

In an embodiment, the cutaway portion 340 may be disposed at the center of the bending portion 350 with respect to the Z direction. For example, the center of the cutaway portion 340 in the Z direction may coincide or overlap with the center of the bending portion 350 in the Z direction. By disposing the cutaway portion 340 in the center of the bending portion 350, the electrolyte may be impregnated into the negative electrode plate 310 and/or the positive electrode plate 320 in a shortest route. Accordingly, the electrolyte impregnation time in the electrode assembly 300 may be reduced. In some embodiments, the uniformity of the electrolyte impregnation within the electrode assembly 300 may be improved.

As such, the electrolyte movement path may be ensured within the electrode assembly 300, and thus, the electrolyte within the electrode assembly 300 may be uniformly or substantially uniformly impregnated, and the electrolyte impregnation time may be reduced (e.g., may be shortened). In some embodiments, the process of discharging gas generated during charging or discharging of the secondary battery to the outside may be more efficiently performed.

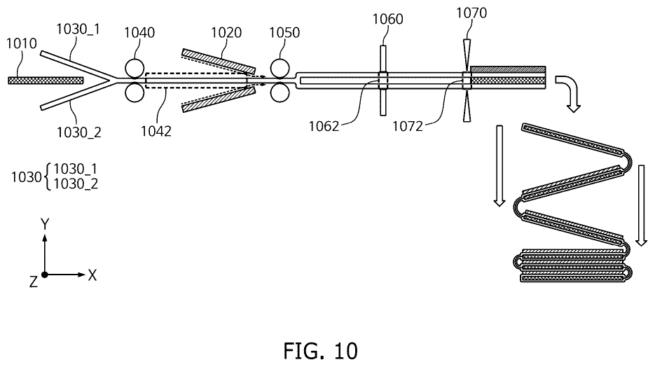

FIG. 10 illustrates an example of a process of manufacturing an electrode assembly according to an embodiment of the present disclosure.

In an embodiment, a plurality of negative electrode plates 1010 may be spaced apart from each other along the X direction between a first separator 1030_1 and a second separator 1030_2 included in a separator structure 1030. The first separator 1030_1 may be disposed on the upper surfaces of the negative electrode plates 1010, and the second separator 1030_2 may be disposed on the lower surfaces of the negative electrode plates 1010.

In an embodiment, the upper surfaces of the negative electrode plates 1010 and the first separator 1030_1, and the lower surfaces of the negative electrode plates 1010 and the second separator 1030_2 may be laminated together by a first lamination apparatus 1040. The upper surfaces of the negative electrode plate 1010 and the first separator 1030_1, and the lower surfaces of the negative electrode plates 1010 and the second separator 1030_2 may be pressed together by the first lamination apparatus 1040. In other embodiments, the upper surfaces of the negative electrode plate 1010 and the first separator 1030_1, and the lower surfaces of the negative electrode plates 1010 and the second separator 1030_2 may be heated and pressed together by the first lamination apparatus 1040. For convenience of illustration, FIG. 10 does not illustrate the negative electrode plate 1010 in the separator structure 1042 that has passed through the first lamination apparatus 1040, but the negative electrode plate 1010 may be between the first separator 1030_1 and the second separator 1030_2 in the separator structure 1042.

In an embodiment, a plurality of positive electrode plates 1020 may be alternately disposed to face the negative electrode plates 1010 with the first separator 1030_1 or the second separator 1030_2 therebetween. In some embodiments, a first set of positive electrode plates 1020_1 from among the positive electrode plates 1020 may be disposed to face the negative electrode plates 1010 with the first separator 1030_1 therebetween, and a second set of positive electrode plates 1020_2 from among the positive electrode plates 1020 may be disposed to face the negative electrode plates 1010 with the second separator 1030_2 therebetween. The first set of positive electrode plates 1020_1 from among the positive electrode plates 1020 and the second set of positive electrode plates 1020_2 from among the positive electrode plates 1020 may be alternately disposed to face the negative electrode plates 1010.

In an embodiment, the first set of positive electrode plates 1020_1 from among the positive electrode plates 1020 and the first separator 1030_1, or the second set of positive electrode plates 1020_2 from among the positive electrode plates 1020 and the second separator 1030_2 may be laminated together by a second lamination apparatus 1050. The first set of positive electrode plates 1020_1 from among the positive electrode plates 1020 and the first separator 1030_1, or the second set of positive electrode plates 1020_2 from among the positive electrode plates 1020 and the second separator 1030_2 may be pressed together by the second lamination apparatus 1050. In some embodiments, the first set of positive electrode plates 1020_1 from among the positive electrode plates 1020 and the first separator 1030_1, or the second set of positive electrode plates 1020_2 from among the positive electrode plates 1020 and the second separator 1030_2 may be heated and pressed together by the second lamination apparatus 1050. FIG. 10 illustrates that the first lamination apparatus 1040 and the second lamination apparatus 1050 are different apparatuses from each other, but the present disclosure is not limited thereto, and the first lamination apparatus 1040 and the second lamination apparatus 1050 may be the same apparatus as each other.

In an embodiment, the first separator 1030_1 and the second separator 1030_2 may be bonded to or attached to each other by a separator bonding apparatus 1060. Portions other than a portion where the separator structure 1030 and the negative electrode plate 1010 are in contact with each other and other than a portion where the separator structure 1030 and the positive electrode plate 1020 are in contact with each other may be bonded together by the separator bonding apparatus 1060.

In an embodiment, the separator structure 1030 may be cut by a separator cutting apparatus 1070. Portions other than a portion where the separator structure 1030 and the negative electrode plate 1010 are in contact with each other and other than a portion where the separator structure 1030 and the positive electrode plate 1020 are in contact with each other may be cut by the separator cutting apparatus 1070.

In an embodiment, the separator structure 1030 may be cut in the shape of a dashed line by the separator cutting apparatus 1070. In another embodiment, the separator structure 1030 may be cut in the shape of a straight line by the separator cutting apparatus 1070.

In an embodiment, the separator structure 1030 having a length less than a ratio (e.g., a predetermined ratio) of the length of the side of the negative electrode plate 1010, which is parallel to or substantially parallel to the Z direction, may be cut by the separator cutting apparatus 1070.

In an embodiment, the central portion of the separator structure 1030 may be cut in the Z direction by the separator cutting apparatus 1070.

In an embodiment, the electrode assembly may be folded in a zigzag manner by bending the bending portion, so that the first set of positive electrode plates 1020_1 from among the positive electrode plates 1020 face the first separator 1030_1 and the second set of positive electrode plates 1020_2 from among the positive electrode plates 1020 face the second separator 1030_2. Accordingly, the electrode assembly may be folded in a zigzag manner, and stacked in the Y direction.

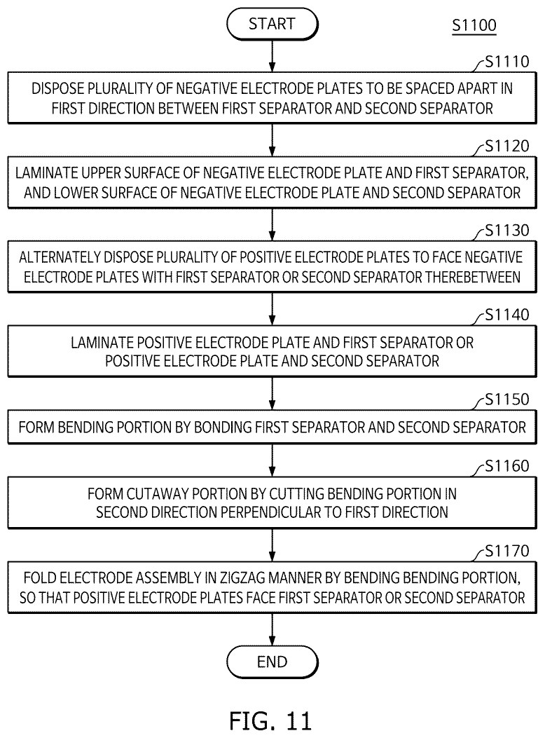

FIG. 11 illustrates a flowchart showing an example of a method S1100 of manufacturing an electrode assembly according to an embodiment of the present disclosure. In an embodiment, the method S1100 may start, and a plurality of negative electrode plates may be disposed to be spaced apart from each other along a first direction between a first separator and a second separator (S1110). In some embodiments, the upper surface of the negative electrode plate and the first separator, and the lower surface of the negative electrode plate and the second separator may be laminated (S1120). In some embodiments, the upper surface of the negative electrode plate and the first separator, and the lower surface of the negative electrode plate and the second separator may be laminated by applying pressure thereto. In other embodiments, the upper surface of the negative electrode plate and the first separator, and the lower surface of the negative electrode plate and the second separator may be laminated by applying heat and pressure thereto.

Thereafter, a plurality of positive electrode plates may be alternately disposed to face the negative electrode plates with the first separator or the second separator therebetween (S1130). In some embodiments, a first set of positive electrode plates from among the positive electrode plates may be disposed to face the negative electrode plates with the first separator therebetween, and a second set of positive electrode plates from among the positive electrode plates may be disposed to face the negative electrode plates with the second separator therebetween. Thereafter, the first set of positive electrode plates from among the positive electrode plates and the first separator or the second set of positive electrode plates from among the positive electrode plates and the second separator may be laminated (S1140).

The first separator and the second separator may be bonded to each other to form a bending portion (S1150). In an embodiment, the bending portion may be disposed at a portion other than a portion where the separator structure and the negative electrode plate are in contact with each other and other than a portion where the separator structure and the positive electrode plate are in contact with each other.

Thereafter, the bending portion may be cut in a second direction perpendicular to or substantially perpendicular to the first direction to form a cutaway portion (S1160).

In an embodiment, the cutaway portion may be formed by cutting the bending portion in the shape of a dashed line. In another embodiment, the cutaway portion may be formed by cutting the bending portion in the shape of a straight line.

In an embodiment, the cutaway portion may be formed by cutting the bending portion with a length less than a ratio (e.g., a predetermined ratio) of the length of the side of the negative electrode plate that is parallel to or substantially parallel to the second direction.

In an embodiment, in a case where the length of a first side of the negative electrode plate, which is parallel to or substantially parallel to the second direction, is longer than the length of a second side of the negative electrode plate, which is perpendicular to or substantially perpendicular to the first side, the cutaway portion may be formed by cutting the bending portion having a length that is obtained by subtracting the length of the second side from the length of the first side in the bending portion.

In an embodiment, in a case where the length of the first side of the negative electrode plate is shorter than or equal to the length of the second side of the negative electrode plate, the cutaway portion may be formed by cutting the bending portion by half the length of the first side in the bending portion.

In an embodiment, the cutaway portion may be disposed at the center of the bending portion with respect to the second direction.

Thereafter, the electrode assembly may be folded in a zigzag manner by bending the bending portion, so that the first set of positive electrode plates from among the positive electrode plates face the first separator and the second set of positive electrode plates from among the positive electrode plates face the second separator (S1170).

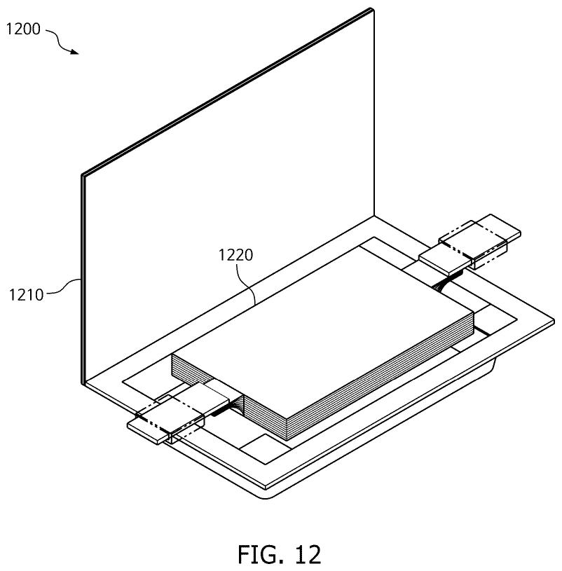

FIG. 12 illustrates an example of a secondary battery 1200 according to an embodiment of the present disclosure. In an embodiment, the secondary battery 1200 may include an electrode assembly 1220 including a separator, and electrode plates having different polarities from each other. A case 1210 may accommodate the electrode assembly. The electrode assembly 1220 may include a separator structure including a first separator and a second separator, a plurality of negative electrode plates spaced apart from each other in a first direction between the first separator and the second separator, and a plurality of positive electrode plates facing the negative electrode plates with the first separator or the second separator therebetween.

In an embodiment, the separator structure may include a bending portion where the first separator and the second separator are bonded to each other.

In an embodiment, the bending portion may include a cutaway portion through which the first separator and the second separator are cut in a second direction perpendicular to or substantially perpendicular to the first direction.

In an embodiment, the cutaway portion may include a plurality of holes. In another embodiment, the cutaway portion may be in the shape of a straight line.

FIG. 12 illustrates a pouch-kind of secondary battery 1200, but the shape of the secondary battery 1200 is not limited thereto. Accordingly, the secondary battery 1200 according to an embodiment of the present disclosure may be a prismatic secondary battery in which an electrode assembly is built in a prismatic case, or a cylindrical secondary battery in which an electrode assembly is built in a cylindrical case.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: electrode assembly
110: negative electrode plate
112: negative electrode tab
120: positive electrode plate
122: positive electrode tab
130: separator

What is claimed is:

1. An electrode assembly comprising:
a separator structure comprising a first separator and a second separator;
a plurality of negative electrode plates spaced from each other along a first direction between the first separator and the second separator; and
a plurality of positive electrode plates on the negative electrode plates with the first separator or the second separator therebetween,
wherein the separator structure comprises a bending portion where the first separator and the second separator are bonded to each other, and
wherein the bending portion has a cutaway portion through which the first separator and the second separator are cut in a second direction perpendicular to the first direction.

2. The electrode assembly as claimed in claim 1, wherein the cutaway portion has a plurality of holes.

3. The electrode assembly as claimed in claim 1, wherein the cutaway portion has a straight line shape.

4. The electrode assembly as claimed in claim 1, wherein a length of the cutaway portion is less than a ratio of a length of a side of an adjacent negative electrode plate from among the negative electrode plates, the side being parallel to the second direction.

5. The electrode assembly as claimed in claim 1, wherein a length of a first side parallel to the second direction of an adjacent negative electrode plate from among the negative electrode plates is longer than a length of a second side of the adjacent negative electrode plate perpendicular to the first side, and a length of the cutaway portion is a value obtained by subtracting the length of the second side from the length of the first side.

6. The electrode assembly as claimed in claim 1, wherein a length of a first side parallel to the second direction of an adjacent negative electrode plate from among the negative electrode plates is shorter than or equal to a length of a second side of the adjacent negative electrode plate perpendicular to the first side, and the length of the cutaway portion is half the length of the first side.

7. The electrode assembly as claimed in claim 1, wherein the cutaway portion is located at a center of the bending portion with respect to the second direction.

8. The electrode assembly as claimed in claim 1, wherein the bending portion is located in a portion where the separator structure and the negative electrode plates are not in contact with each other, and in a portion where the separator structure and the positive electrode plates are not in contact with each other.

9. The electrode assembly as claimed in claim 1, further comprising:
a plurality of negative electrode tabs joined to the negative electrode plates; and
a plurality of positive electrode tabs joined to the positive electrode plates.

10. A method of manufacturing an electrode assembly, the method comprising:
disposing a plurality of negative electrode plates to be spaced from each other along a first direction between a first separator and a second separator of a separator structure;
laminating upper surfaces of the negative electrode plates and the first separator to each other, and lower surfaces of the negative electrode plates and the second separator to each other;
alternately disposing a plurality of positive electrode plates on the negative electrode plates with the first separator or the second separator therebetween;
laminating a first set of positive electrode plates from among the positive electrode plates and the first separator to each other, or a second set of positive electrode plates from among the positive electrode plates and the second separator to each other;
forming a bending portion by bonding the first separator and the second separator to each other;
forming a cutaway portion by cutting the bending portion in a second direction perpendicular to the first direction; and
folding the electrode assembly in a zigzag manner by bending the bending portion, so that the first set of positive electrode plates from among the positive electrode plates face the first separator and the second set of positive electrode plates from among the positive electrode plates face the second separator.

11. The method as claimed in claim 10, wherein the forming of the cutaway portion comprises cutting the bending portion in a shape of a dashed line.

12. The method as claimed in claim 10, wherein the forming of the cutaway portion comprises cutting the bending portion in a shape of a straight line.

13. The method as claimed in claim 10, wherein the forming of the cutaway portion comprises cutting the bending portion by a length less than a ratio of a length of a side parallel to the second direction of an adjacent negative electrode plate from among the negative electrode plates.

14. The method as claimed in claim 10, wherein a length of a first side parallel to the second direction of an adjacent negative electrode plate form among the negative electrode plates is longer than a length of a second side of the adjacent negative electrode plate perpendicular to the first side, and
wherein the forming of the cutaway portion comprises cutting the bending portion by a length obtained by subtracting the length of the second side from the length of the first side.

15. The method as claimed in claim 10, wherein a length of a first side parallel to the second direction of an adjacent negative electrode plate from among the negative electrode plates is shorter than or equal to a length of a second side of the adjacent negative electrode plate perpendicular to the first side, and
wherein the forming of the cutaway portion comprises cutting the bending portion by half the length of the first side.

16. The method as claimed in claim 10, wherein the cutaway portion is disposed at a center of the bending portion with respect to the second direction.

17. The method as claimed in claim 10, wherein the bending portion is disposed in a portion where the separator structure and the negative electrode plates are not in contact with each other, and in a portion where the separator structure and the positive electrode plates are not in contact with each other.

18. A secondary battery comprising:
an electrode assembly; and
a case accommodating the electrode assembly,
wherein the electrode assembly comprises:
a separator structure comprising a first separator and a second separator;
a plurality of negative electrode plates spaced from each other along a first direction between the first separator and the second separator; and
a plurality of positive electrode plates on the negative electrode plates with the first separator or the second separator therebetween,
wherein the separator structure further comprises a bending portion where the first separator and the second separator are bonded to each other, and
wherein the bending portion has a cutaway portion through which the first separator and the second separator are cut in a second direction perpendicular to the first direction.

19. The secondary battery as claimed in claim 18, wherein the cutaway portion has a plurality of holes.

20. The secondary battery as claimed in claim 18, wherein the cutaway portion has a straight line shape.
